(19) United States
(12) Patent Application Publication
(10) Pub. No.: US 2008/0036116 A1
(43) Pub. Date: Feb. 14, 2008

(54) Mold for Forming a Candle Body Having an Embossed Design

(76) Inventor: Ivan Lajoie, Markham (CA)

Correspondence Address: LADAS & PARRY LLP, 224 SOUTH MICHIGAN AVENUE, SUITE 1600, CHICAGO, IL, 60604, US

(21) Appl. No.: 11/547,838

(22) PCT Filed: Apr. 14, 2005
(86) PCT No.: PCT/CA05/00564

§ 371 Date: Oct. 6, 2006

(51) Int. Cl. B29C 33/16

(52) U.S. Cl. 264/299; 425/3

(57) ABSTRACT

A mold for forming a candle body having a design embossed on at least one surface thereof is provided. The mold includes a mold body having at least one inner side surface defining a mold cavity open at its top for receiving liquefied candle wax. The mold also includes an embossing mold having an embossing surface for forming the embossed design on the surface of the candle. A securing component provides for selectively securing the embossing mold to the inner side surface of the mold body such that the embossing mold may be secured to the mold body at any location on the inner side surface.

### FIELD OF THE INVENTION

The present invention relates to a mold for forming a candle body having an embossed design on a surface thereof.

### BACKGROUND OF THE INVENTION

Candles having a three-dimensional image embossed on one or more sides (commonly referred to as embossed candles) have been made for some time. Traditional methods of creating an embossed candle involve rolling a candle over an embossing plate having an embossing surface with a raised negative image of the design to be imparted. The embossing plate may be heated to soften the candle and facilitate embossing. An example of this type of apparatus is disclosed in U.S. Pat. No. 3,649,151 to Mathews.

Another apparatus for creating embossed candles comprises a primary mold for defining the general shape of the candle, and one or more secondary molds for imparting the embossed design which are hung from the interior sidewalls of the primary mold using hanger means. Hot candle wax is then poured into the mold cavity of the primary mold, filling both the primary mold and secondary molds suspended therefrom. An example of this type of apparatus is disclosed in U.S. Pat. No. 3,952,992 to Vyprachticky. This type of apparatus has several disadvantages. Firstly, the secondary molds are hung from the upper edge of the primary mold. This restricts the available positions for hanging the secondary molds. Secondly, this type of apparatus imparts an impression of the hanger means on the candle surface thereby interfering with the embossed design. Thirdly, the hanger means can typically be used only on rectilinear surfaces of the primary mold and not on curved surfaces, or at least not on both rectilinear and curved surfaces.

U.S. Pat. No. 6,228,304 to Silbergeld discloses another method for creating an embossed candle that uses photolithography to create a rubber stamp having a recessed negative image of the design to be imparted to the candle. Plaster cast copies of the rubber stamp are then created, for a polygonally shaped candle (e.g. square) one plaster cast copy is made per candle side. The plaster castings are then connected with the design facing outwards. The hollow interior portion defined by the connected plaster copies is then filled to produce a cast copy of the ultimate candle design. A rubber mold is then created by forming a dam around the cast copy, pouring rubber into the space between the exterior surface of the cast copy and the dam, and curing the rubber. The rubber mold is released from the cast copy by cutting or stretching the rubber mold free of the cast copy. A candle is produced by pouring liquefied candle wax into the mold and allowing it to cool. The candle may be removed from the rubber mold by either stretching or opening the mold along the previously made cut line. Cylindrical candles can be made by wrapping the rubber stamp to form a cylinder having the design facing outwards. The rubber stamp is then placed in a cylindrical tube and a plaster cast of the rubber stamp is made. Using a larger tube as a dam, the cast is used to make a rubber mold. Once the rubber sets, the dam is removed and the rubber mold can be cut from free from the cast.

This method has several disadvantages. Firstly, the process of creating the rubber mold requires many process steps which make it costly and time consuming to produce. Secondly, once created the rubber mold can only be used to create one type of candle. If a change in either the general shape of the candle or the embossed design is desired, a new rubber mold must be created thereby increasing the time and cost of producing the candles.

Other types of molds and methods relating thereto are taught by U.S. Pat. No. 6,153,137 to Yonn, U.S. Pat. No. 6,568,934 to Butler, U.S. Pat. Nos. 6,491,517, 6,299,435 and 6,210,153 to Freeman et al., and U.S. Pat. Nos. 6,132,834, 6,070,754, 5,736,168, and 3,474,498.

### SUMMARY OF THE INVENTION

The present invention provides a mold, apparatus and method for forming a candle body having a design embossed on at least one surface thereof. The present invention allows embossed candle bodies to be created using less complicated molds and using fewer pieces of apparatus. The present invention also allows relatively quick and easy changes between different embossing molds, can be used with mold bodies of varying shape, and may be used in either manual or automated candle making processes using either liquefied candle wax or compression molding techniques.

According to one aspect of the present invention, there is provided a mold for forming a candle body having a design embossed on at least one surface thereof, comprising: a mold body having at least one inner side surface defining a mold cavity open at one end for receiving liquefied candle wax; an embossing mold having an embossing surface for forming the embossed design on the surface of the candle body; and a securing component for selectively securing the embossing mold to the inner side surface of the mold body such that the embossing mold may be secured to the mold body at any location on the inner side surface.

According to another aspect of the present invention, there is provided an apparatus for forming a candle body having a design embossed on at least one surface thereof, comprising: a mold body having at least one side wall defining a mold cavity open at opposite ends thereof for receiving candle wax, the mold body defining an opening in the side wall; an embossing mold having an embossing surface for forming the embossed design on the surface of the candle body; and a plunger for moving the embossing mold between a retracted position in which the embossing mold is withdrawn from the opening in the side wall and an extended position in which the embossing mold is introduced into the opening.

According to a further aspect of the present invention, there is provided a method for forming a candle body having a design embossed on at least one surface thereof, comprising the steps of: selectively positioning an embossing mold within a mold cavity defined by a mold body; securing the embossing mold to the mold body using magnets; pouring liquefied candle wax into the mold cavity; retaining the liquefied candle wax within the mold cavity for a period of time sufficient for the liquefied candle wax to solidify into a candle body; and removing the candle body from the mold cavity.

According to yet a further aspect of the present invention, there is provided a method for embossing a design on a candle body, comprising the steps of: retaining a candle body within a mold cavity defined by a mold body; aligning an embossing mold with a surface of the candle body on which the design is to be embossed; and compressing the wax into the embossing mold with sufficient pressure to impart the embossed design.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 is a perspective view of one embodiment of a mold having an embossing mold for securing to a mold body;

FIG. 2 is a sectional view of the mold of FIG. 1;

FIG. 3 is a schematic view of a design to be embossed on a candle body;

FIG. 4 is a side view of an embossing mold;

FIG. 5 is a plan view of an embossing mold having an embossing surface for forming the embossed design of FIG. 3;

FIG. 6 is a sectional view of another embodiment of a mold having an embossing mold for securing within a recess of a mold body;

FIG. 7 is a sectional view of the mold of FIG. 6 showing the embossing mold secured within the recess;

FIG. 8 is a perspective view of one embodiment of a multi-part mold showing the mold parts separated;

FIG. 9 is a perspective view of another embodiment of a multi-part mold showing the mold parts separated;

FIG. 10 is a side view of another embodiment of a mold;

FIG. 11 is a top view of the mold of FIG. 10;

FIG. 12 is an alternate side view of the mold of FIG. 10 showing a side opening in the mold body;

FIG. 13 is a top view of an alternate platen for use with the mold of FIG. 10;

FIG. 14 is a top view of the platen of FIG. 13;

FIG. 15 is a top view of a mold assembly for releasably securing an embossing mold to a mold body; and

FIG. 16 is a top view of a magnetic tool for an embossing mold.

Similar references are used in different figures to denote similar components.

### DETAILED DESCRIPTION OF THE EMBODIMENTS

Referring now to FIGS. 1 and 2, a mold 20 for forming a candle body having an embossed design will be described. The term “candle body” is used herein to refer to a wax body including wicked and non-wicked candle bodies. The mold 20 comprises a mold body 22 having an inner side surface 24 defining a mold cavity 26 open at its top for receiving liquefied candle wax. The mold 20 also includes an embossing mold 28 having an embossing surface 30 for forming the embossed design on a surface of the candle body, and securing means, for example one or more magnets 32, for adjustably securing the embossing mold 28 to the inner side surface 24 of the mold body 22. The securing means may comprise means for releasably securing the embossing mold 28 to the mold body 22. In some embodiments, the securing means may comprise an adhesive, hook and loop fasteners such as VELCRO™, screws, bolts, rivets, double sided tape, or other type of securing component known in the art.

The mold body 22 may be made of wood, plastic, metal (e.g. steel or aluminum) or other suitable material. The mold body 22 may include a bottom wall, or may be open at its bottom. In cases where the mold body 22 is open at its bottom, the mold body 22 is supported by a support member (not shown) such as a mold plate or platform which forms a bottom wall of the mold cavity 26. When the support member is removed, the candle body can be removed from the top or bottom of the mold body 22. The mold body 22 may be any shape, for example the footprint of the mold body 22 may be circular, square, rectangular, or triangular. The inner side surface 24 may be vertical or sloped (oblique). The mold body 22 shown in FIGS. 1 and 2 defines a substantially cylindrical mold cavity 26.

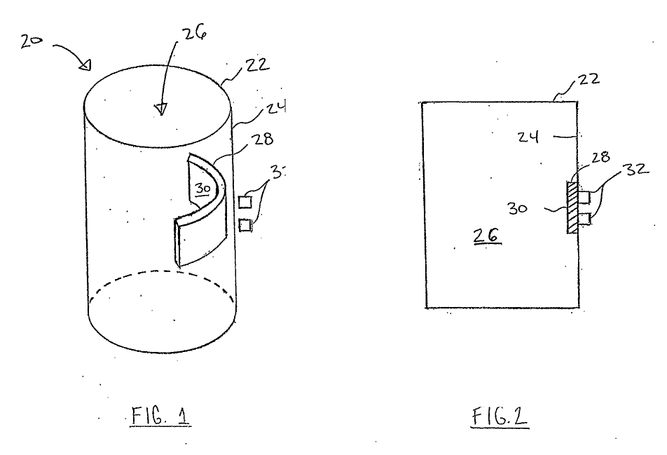

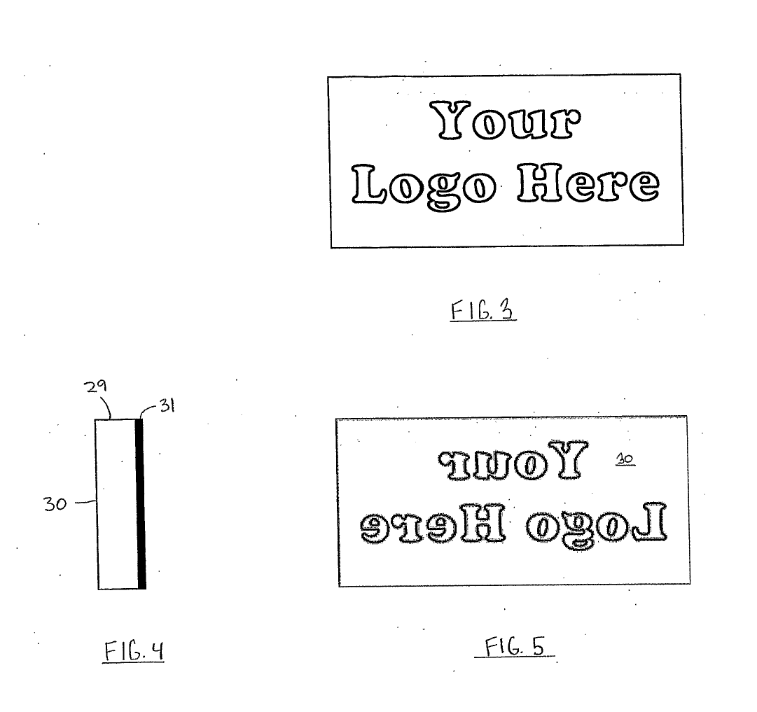

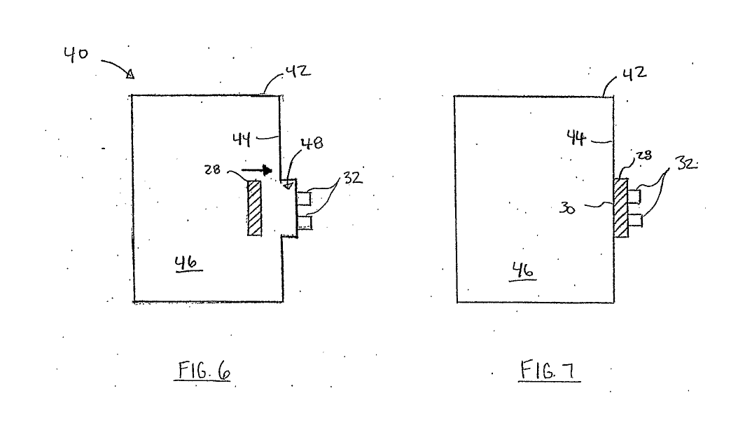

The embossing mold 28 may be a flexographic printing plate (also known as a flexoplate), for example a water-washable, chemical washable, UV only or chemical only flexographic printing plate. The embossing surface 30 is created on the flexographic printing plate using techniques known in the art of flexographic printing. An example of a suitable flexographic printing plate which may be used to create an embossing mold 28 is the Cosmolight™ product from Toyobo Co., Ltd. (Osaka, Japan). As shown in FIGS. 4 and 5, the embossing mold 28 comprises a water-washable flexographic printing plate comprising a metal backing plate 31 covered by a layer of water-soluble photoreactive polymer 29 (photopolymer). Photopolymers are light sensitive polymeric materials which react (cure) when exposed to a certain wavelength of light, for example ultraviolet (UV) light. The photopolymer layer 29 is a water-soluble gel-like material that, when exposed to the proper wavelength of UV light, cures into a hard plastic-like material which is no longer soluble in water. Any areas of the photopolymer layer 29 that are not contacted by the light will remain uncured and water-soluble. Depending on the particular type of flexographic printing plate selected and the properties of its photopolymer layer, the cured photopolymer may be quite durable. For example, the photopolymer may be selected to create an embossing mold suitable for use in compression molding where the embossing mold is held against the candle body while it is pressed to impart the embossed design.

The embossing mold 28 is secured within the mold cavity 26 opposite the inner side surface 24 with the embossing surface 30 facing inwardly toward the center of the mold cavity 26 and the metal backing plate 31 facing the inner side surface 24. The metal backing plate 31 of the embossing mold 28 may be formed of a flexible metal capable of being shaped, for example to conform to the shape (e.g. curvature) of the inner side surface 24. In other embodiments, the metal backing plate 31 is mechanically deformable so that it may be permanently shaped to conform to the shape of the inner side surface 24. In this manner, the embossing mold 28 may be either temporarily or permanently shaped to corresponding to the shape (e.g. curvature) of the inner side surface 24.

When magnets 32 are used for the securing means, the metal backing plate 31 must be formed of a magnetically responsive metal such as steel. In such cases, the mold body 22 may be formed of a magnetically responsive metal or may be magnetically neutral. The magnets 32 must be appropriately selected for the mold body 22 to ensure that a sufficient magnetic force reaches the metal backing plate 31 of the embossing mold 28 for securing of the embossing mold 28. As shown in FIGS. 1 and 2, the magnets 32 may be secured to the outer surface of the mold body 22. In other embodiments, the magnets 32 are disposed between the inner side surface 24 and the embossing mold 28. The magnets 32 allow the embossing mold 28 to be secured to the mold body 22 at any location on the inner side surface 24. The magnets 32 also allow embossing molds to be switched relatively quickly and easily, thereby reducing setup time when candle bodies having different embossed designs are to be formed.

Referring to FIG. 3 to 5, a method for creating an embossing surface 30 on an embossing mold 28 comprising a water-washable flexographic printing plate will now be briefly described for illustrative purposes and is not intended as a limitation of the present invention. In the first step, a two-dimensional image or design to be embossed on a surface of the candle body is selected (for example, the text “Your Logo Here” as shown in FIG. 3). A negative image of the desired design is then created on a transparency or film, for example an adhesive backed film. In some cases, the negative image may be photocopied onto the film. The film is then placed over the photopolymer layer 29. If the film has an adhesive backing, a protective covering over the adhesive is peeled away and the adhesive side of the film is pressed against the photopolymer layer 29. The film is then exposed to UV light of the required wavelength. The UV light causes the photopolymer layer 29 to react (cure) in the transparent portions of the film not covered by negative image. The required exposure time depends on the particular photopolymer used. After the required exposure time has elapsed the film negative is removed.

The embossing mold 28 is then washed using a suitable solvent, water in the case of water-washable flexographic printing plates, and a small brush such as a medium bristle tooth brush, an air gun, a chemical wash, or a water wash to remove the uncured photopolymer and reveal the embossing surface 30 (for example, the negative image of the “Your Logo Here” as shown in FIG. 5). The embossing surface 30 is a three-dimensional negative design corresponding to the embossed design which is to appear on the surface of the candle body. The embossing surface 30 will have either a raised or recessed design depending on whether the embossed design is recessed or raised (i.e. if the embossed design is to be recessed, the negative design on the embossing surface 30 is raised and vice versa). The embossing mold 28 is then dried, for example using hot air. The embossing mold 28 may then be re-exposed to UV light to react any un-reacted photopolymer remaining. The embossing mold 28 may comprise a chemical solvent-based flexographic printing plate with the embossing surface 30 created using techniques of solvent-based flexographic printing known in the art similar to the water-based procedure described above.

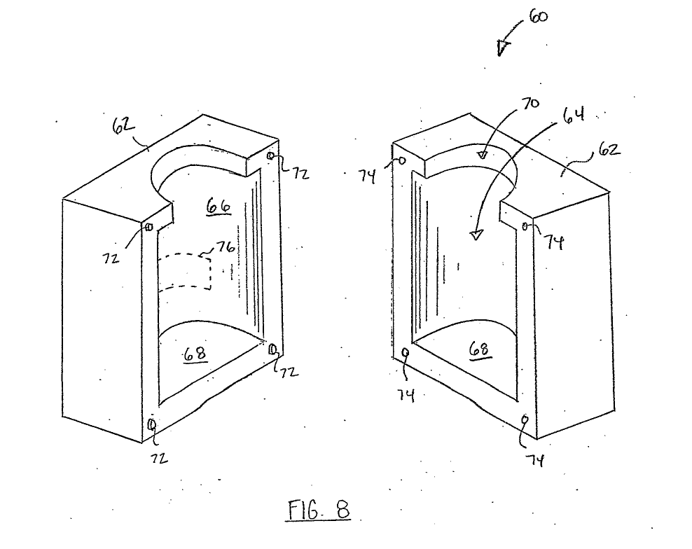

FIGS. 6 and 7 show a mold 40 similar to the mold 20 having a recess for receiving the embossing mold 28. The mold 40 comprises a mold body 42 having an inner side surface 44 defining a mold cavity 46 open at its top for receiving liquefied candle wax. A recess 48 is formed in the inner side surface 44. The embossing mold 28 is secured within the recess 48 with the embossing surface 30 directed inwardly toward the center of the mold cavity 46. The embossing mold 28 may be shaped so that the embossing surface 30 corresponds in shape to the inner side surface 44 when the embossing mold 28 is secured within the recess 48. The embossing mold 28 may be secured within the recess 48 using magnets 32 disposed against the outer surface of the mold body 22 opposite the embossing mold 28 as shown in FIGS. 6 and 7. In other embodiments, the magnets 32 are received in the recess 48 and disposed between the inner side surface 24 and the metal backing plate 31 of the embossing mold 28.

As described previously, in some embodiments the mold bodies 22 and 42 may include a bottom wall. In other embodiments, the mold cavities 26 and 46 are open at the top and bottom (or opposite ends thereof) and a closed bottom is formed by a support member (not shown) such as a mold plate or platform beneath the mold body 22 or 42. The support member cooperates with the mold body 22 or 42 to form a closed bottom for supporting the mold body 22 or 42 and temporarily retaining the liquefied candle wax received therein. The use of a separate support member allows a candle body formed in the mold 20 or 40 to be removed from the open bottom or top of the mold cavity 26 or 46 after the support member has been withdrawn.

A method for forming a candle body having an embossed design using the mold 20 or 40 will now be described. First, the embossing mold 28 is positioned opposite the inner side surface of the mold body. The embossing mold 28 is then secured to the mold body by disposing the magnets 32 on the outside surface of the mold body opposite the embossing mold 28 or between the metal backing plate 31 of the embossing mold 28 and the inner side surface of the mold body. Next, liquefied candle wax is poured into the mold cavity through the open top of the mold. The liquefied candle wax is prepared using techniques known in the candle making art. An optional step of inserting a wick into the liquefied candle wax may then be performed. The liquefied candle wax is then retained within the mold cavity for a period of time sufficient for the liquefied candle wax to solidify into a candle body. After the candle wax has solidified, the candle body is removed from the mold. If a wick was not inserted in the liquefied candle wax, the candle body must be wicked. Wicking generally involves drilling a hole for the wick, inserting the wick, trimming the wick to the desired height, and heat sealing the wick hole. If the mold has an open bottom, a preliminary step of placing the mold on the support member or moving the support member beneath the mold is required, and the step of removing the candle body from the mold includes a step of withdrawing the support member from the mold.

In some embodiments of the present invention, the candle body is not wicked. The candle body includes a recess or depression, typically in the top of the candle body, or a hole extending through the center of the candle, which may be used to receive a secondary candle such as a tea light candle. The secondary candle may also be a smaller pillar-type candle, chaffing candle, or other suitable candle. In these embodiments, the candle body serves as a candle holder and, optionally, an illumination body for the secondary candle. In such applications, the candle body may be used to illuminate or accent the embossed design formed therein. In yet other embodiments, another source of illumination may be received in the recess instead of a secondary candle such as, for example, a light bulb.

The candle wax may be paraffin-based, and may include dyes for colouring, scents, and/or processing additives for increasing the dispersion of colours and scents, and/or increasing hardness or plasticity. Other types of candle wax and additive may also be used. Objects such as message blocks, leaves, pine cones etc. may also be included in the candle wax.

Referring now to FIG. 8, a multi-part mold 60 for forming a candle body having an embossed design will be described. The mold 60 comprises at least two mold parts 62 which combine to define a mold cavity 64 open at its top for receiving liquefied candle wax. The mold 60 has an inner side surface 66. The mold parts 62 combine to form a bottom wall 68 and a top opening 70 through which the liquefied candle wax is introduced into the mold cavity 64. Projections 72 and holes 74 defined in the respective mold parts 62 assist to hold the mold parts 62 together when combined. A dam may also be constructed around the combined mold parts 62 for additional support. The mold parts 62 may be formed of a resilient material, for example a rubber or similar elastomeric material. A magnetic region 76 in the mold 60 is created by one or more magnets 32 disposed within one of the mold parts 62 opposite the inner side surface 66. The magnets 32 are embedded within the corresponding mold part 62. The embossing mold 28 is secured to the inner side surface 66 by positioning it opposite the magnets 32 in the magnetic region 76. Magnets 32 may be located in a single magnetic region 76 as shown in FIG. 8, or magnets 32 may be disposed within the mold 60 to create multiple magnetic regions 76 to increase the positions at which embossing mold 28 may be secured to the inner side surface 66. In some embodiments, magnetic regions 76 may be distributed throughout the inner side surface 66 such that the embossing mold 28 may be secured at any location on the inner side surface 66.

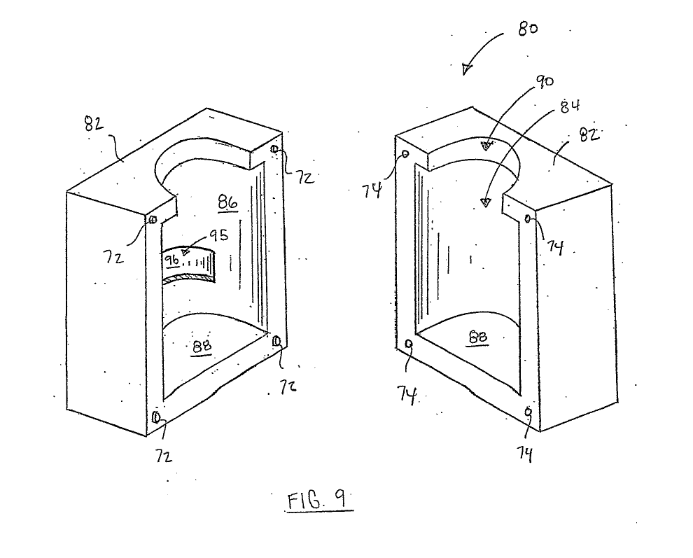

FIG. 9 shows a multi-part mold 80 similar to the mold 60 having a recess for receiving the embossing mold 28. The mold 80 comprises at least two mold parts 82 which combine to define a mold cavity 84 open at its top for receiving liquefied candle wax. The mold 80 has an inner side surface 86. The mold parts 82 combine to form a bottom wall 88 and a top opening 90 through which the liquefied candle wax is introduced into the mold cavity 84. A recess 95 is formed in the inner side surface 86. A magnetic region 96 in the recess 95 is created by one or more magnets 32 disposed within one of the mold parts 62 opposite the recess 95. The embossing mold 28 is secured to the inner side surface 86 by positioning it within the recess 95 opposite the magnets 32 in the magnetic region 96. In other embodiments, multiple recesses having magnetic regions are formed in the inner surface 86. In some embodiments, magnets 32 may also be disposed opposite the inner side surface 86 in regions where the mold 80 has no recess. In yet other embodiments, the magnets 32 may be disposed within one of the mold parts 62 to form a raised area which protrudes into the mold cavity 84.

A method for forming a candle body having an embossed design using the mold 60 or 80 will now be described. As a preliminary step, the mold parts must be combined. Next the embossing mold 28 is positioned opposite the inner side surface of the mold. The embossing mold 28 is then secured to the mold by positioning the embossing mold 28 opposite the magnetic region in the inner side surface. Next, liquefied candle wax is poured into the mold cavity through the top opening of the mold. An optional step of inserting a wick into the liquefied candle wax may then be performed. The liquefied candle wax is then retained within the mold cavity for a period of time sufficient for the liquefied candle wax to solidify into a candle body. After the candle wax has solidified, the mold parts are separated and the candle body is removed from the mold.

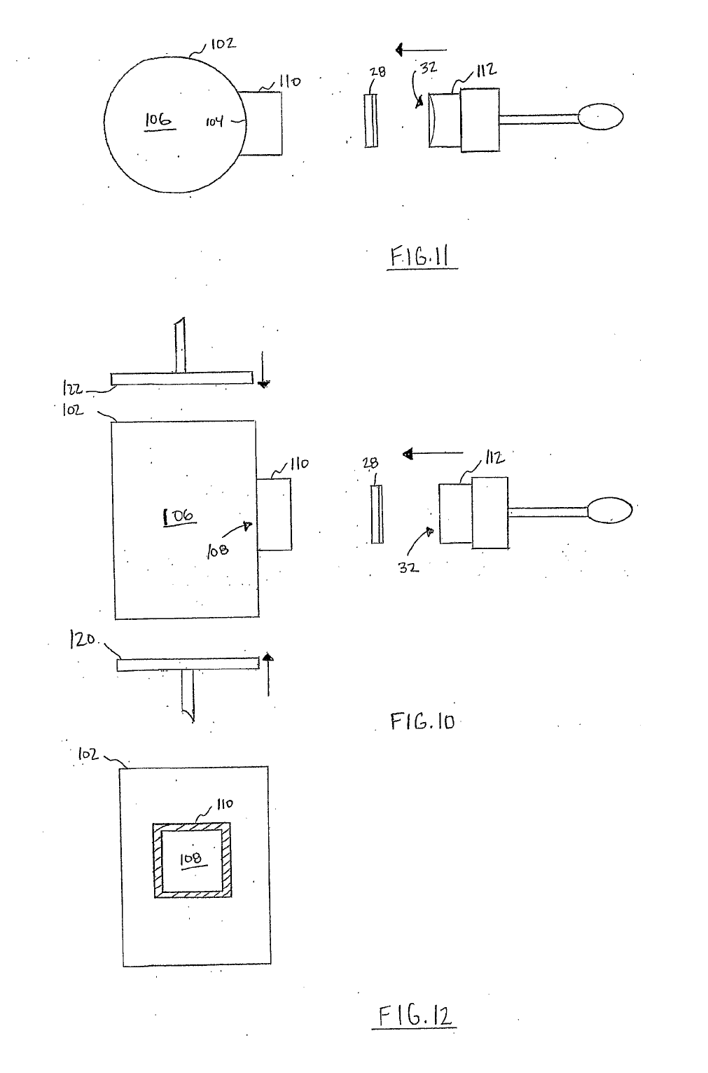

Referring now to FIG. 10 to 14, a mold 100 for forming a candle body having an embossed design will be described. The mold 100 comprises a mold body 102 having at least one side wall 104 defining a mold cavity 106 open at opposite ends thereof for receiving candle wax. The mold body 102 also defines a side opening 108 in the side wail 104. The mold 100 also includes an embossing mold 28 having an embossing surface 30 for forming the embossed design on a surface of the candle body. The embossing mold 28 is introduced into the mold cavity 106 through the side opening 108. The embossing mold 28 is sized to fit the side opening 108. A piston, plunger or other means is used to move the embossing mold 28 between a horizontally retracted position in which the embossing mold 28 is withdrawn from the side opening 108 (as shown in FIG. 10) and a horizontally extended position in which the embossing mold 28 is introduced into the opening 108. The mold body 102 may also include a receptacle 110 defining a channel in communication with the side opening 108 for receiving the embossing mold 28.

In some embodiments a support member, for example a lower mold plate or platform, cooperates with the mold body 102 to form a closed bottom for the mold 100. A platen 112 may be used for securing the embossing mold 28 using securing means, for example one or more magnets 32 disposed against a surface of the platen 112 or integrally formed in the platen 112. The securing means may comprise means for releasably securing the embossing mold 28 to the platen 112. The platen 112 is sized and configured to fit the channel in the receptacle 110. The platen 112 may be shaped to conform to the curvature of the inner side wall 104 as shown in FIGS. 13 and 14. The platen 112 is operably connected to the means for moving the embossing mold 28 between its horizontally retracted position and horizontally extended position. The platen 112 may be moved using either manual or automatic means, for example an automated pneumatic or hydraulic piston. Liquefied candle wax may be introduced into the mold cavity 106 to produce a candle body similar to the methods described above.

In other embodiments, the platen 112 may be used to press against a candle body formed in the mold 100. In one embodiment, the mold 100 is used in a hydraulic candle press or candle extruder such as those manufactured by Officine Meccaniche Ponita (Ponita, Italy) or Arthur Weissbach GmbH (Fulda, Germany). The means for moving the embossing mold 28 comprises an embossing piston moving along a substantially horizontal axis (not shown). The candle press comprises an upper piston 120 and lower piston 122 sized to fit the mold cavity 106. The lower piston 122 is introduced into the open bottom of the mold cavity 106 to form a closed bottom. The upper piston 120 is introduced into the open top of the mold cavity 106 to form a closed top. In operation powdered or pelleted candle wax, for example powered paraffin wax, is gravity feed from a feed hopper (not shown) into the mold cavity 106. The upper and lower pistons 120 and 122 are then used to compress the wax within the mold cavity 106 by exerting pressure from the top and bottom of the mold cavity 106. The embossing piston is then used to press the platen 112 having the embossing mold 28 secured to it into the candle body to create the embossed design. The embossing mold 28 must be properly selected to ensure that it can handle the compression forces exerted upon it when the embossing mold 28 held in position in relation to the candle body. Where the embossing mold comprises a flexographic printing plate, the photopolymer must be selected to ensure that when cured the photopolymer layer 29 can handle the compression forces exerted on it.

A method for forming a candle body having an embossed design using the mold 100 Will now be described. First, the lower piston 122 is introduced into the mold cavity 106 through the open bottom forming a closed bottom for retaining candle wax. Next, the embossing mold 28 is introduced into the side opening 108 of the mold 100. Powdered candle wax is then introduced into the mold cavity 106. Next, the upper piston 120 is introduced into the mold cavity 106 through the open top forming a closed top. The upper and lower pistons 120, 122 are then used to compress the wax within the mold cavity 106 by exerting pressure from the top and bottom of the mold cavity 106. The embossing piston exerts sufficient pressure to prevent the embossing mold 28 from retracting from the side opening 108 but does not exert a substantial lateral pressure against the forming candle body. After the pistons 120, 122 have applied sufficient pressure for the required period of time, the powdered candle wax will have solidified into a candle body. The pressure and time required depends on the type of candle wax used and the size of the candle body to be formed, among several factors.

During and/or immediately after the candle body is formed, the embossing piston is used to press the platen 112 having the embossing mold 28 secured to it into the candle body. After applying a sufficient amount of pressure for the required amount of time, the embossed design will be pressed into the surface of the candle body opposite the side opening 108. The embossing piston, and upper and lower pistons 120 and 122 are then withdrawn, and the candle body may be removed from the open top or bottom of the mold cavity 106.

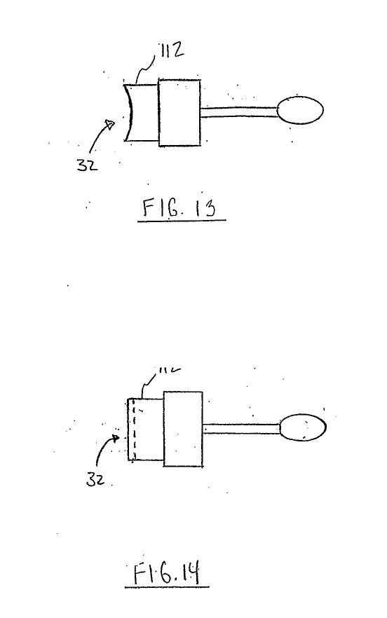

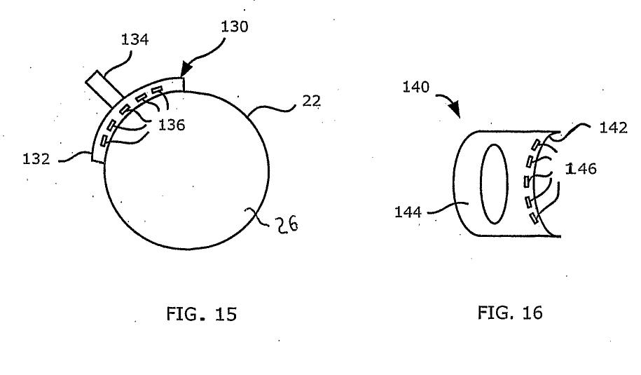

Referring now to FIG. 15, a magnetic assembly and magnetic tool 130 for use with a mold, such as the mold 20, will now be described. The magnetic tool 130 includes a faceplate 132 having a plurality of spaced apart magnets 136 embedded therein. The magnets 136 are located opposite an inner surface of the faceplate 132. A handle 134 is attached to the rear surface of the faceplate 132 and extends rearwardly therefrom. The handle 134 may have any known configuration such as, for example, a shaft or simple cutout for gripping by the user.

As shown in FIG. 15, the faceplate 132 is secured to the mold body 22 using the magnets 136 embedded therein. Although not shown, in use an embossing mold 28 will be positioned within the mold cavity 26 opposite the faceplate 132. The magnets 136 within the faceplate 132 releasably secure the embossing mold 28 at a desired position. In these applications, the magnetic tool 130 provides the securing component. The magnetic tool 130 distributes the magnets 136 and the corresponding magnetic field(s) produced, improving the security of attachment. The handle 134 facilitates the ease of handling the mold equipment and facilitates the manufacturing process.

Referring now to FIG. 16, another embodiment of a magnetic tool 140 will be described. The magnetic tool 140 includes a faceplate having an inner surface or face 142 having a plurality of magnets 146 embedded therein. The magnets 146 are spaced apart and located opposite the inner surface 142. An integral handle 144 defined by a central cutout is also provided. Similar to the magnetic tool 130, the magnetic tool 140 distributes the magnets 146 and the corresponding magnetic field(s) produced.

The magnets 136 and 146 may be embedded within the tools 130 and 140 as shown in FIGS. 15 and 16, or the magnets 136 and 146 may be embedded in the tools but positioned on the inner surface. In some embodiments, the magnets 136 and 146 are positioned to be flush with the inner surface of the tools 130 and 140.

The magnetic tool 140 may be used to releasably secure the embossing mold 28 to the mold body 22 as described above. In these applications, the magnetic tool 140 provides the securing component. In other embodiments, the magnetic tool 130 or 140 may be used to remove the embossing mold 28 from a formed candle body after it has been removed from the mold 20. If the magnetic tool 130 or 140 is only to be used for the latter purpose, the magnets in the magnetic tool 130 or 140 need not be as strong as when the tool 130 or 140 is used to releasably secure the embossing mold 28. It will be appreciated by persons skilled in the art that the shape of the rearward, outwardly oriented surface of the embossing mold and the outer surface of the mold body 22 may not be the same in some embodiments. However, in some embodiments, the shape and configuration of these surfaces may be the same or substantially similar such that the magnetic tools 130 and 140 may be used to perform one or both of the above described functions.

Although the present invention has been described with reference to illustrative embodiments, it is to be understood that the invention is not limited to these precise embodiments, and that various changes and modifications may be effected therein by one skilled in the art. All such changes and modifications are intended to be encompassed in the appended claims.

What is claimed is:

1. A mold for forming a candle body having a design embossed on at least one surface thereof, comprising:
a mold body having at least one inner side surface defining a mold cavity open at one end for receiving liquefied candle wax;
an embossing mold having an embossing surface for forming the embossed design on the surface of the candle body; and
a securing component for selectively securing the embossing mold to the inner side surface of the mold body such that the embossing mold may be secured to the mold body at any location on the inner side surface.

2. The mold as claimed in claim 1, wherein the embossing mold is releasably securable to the inner side surface.

3. The mold as claimed in claim 1 or 2, wherein the mold body defines a substantially cylindrical mold cavity.

4. The mold as claimed in any one of claims 1 to 3, wherein the embossing mold comprises a metal backing plate formed of a magnetically responsive metal, and the securing component comprises one or more magnets disposed against a surface of the mold body.

5. The mold as claimed in claim 4, wherein the magnets are disposed between the inner side surface and the embossing mold.

6. The mold as claimed in claim 4, wherein the magnets are disposed against an outer surface of mold body.

7. The mold as claimed in any one of claims 1 to 6, wherein a recess formed in the inner side surface of the mold body, the embossing mold securable within the recess with the embossing surface directed inwardly toward the center of the mold cavity.

8. The mold as claimed in claim 7, wherein the embossing surface corresponds in shape to the inner side surface of the mold body.

9. The mold as claimed in claims 7 or 8, wherein the embossing mold comprises a metal backing plate formed of a magnetically responsive metal, and the securing component comprises one or more magnets disposed against a surface of the mold body.

10. The mold as claimed in claim 9, wherein the magnets are disposed between the inner side surface and the embossing mold.

11. The mold as claimed in claim 9, wherein the magnets are disposed against an outer surface of mold body, the embossing mold secured within the recess of the mold body by the magnets disposed on the outer surface of the mold body.

12. The mold as claimed in any one of claims 1 to 11, further comprising a support member cooperating with the mold body to form a closed bottom for supporting the mold body and temporarily retaining the liquefied candle wax received therein.

13. The mold as claimed in claim 1, wherein the mold body comprises at least two mold parts which combine to define the mold cavity.

14. The mold as claimed in claim 4 or 9, wherein the securing component comprises one or more magnets disposed within the mold body.

15. The mold as claimed in any one of claims 1 to 14, wherein the embossing mold comprises a flexographic printing plate.

16. The mold as claimed in any one claims 4 to 11, wherein the embossing mold comprises a flexographic printing plate having a metal backing plate formed of a magnetically responsive metal.

17. The mold as claimed in any of claims 1 to 3, wherein the securing component is selected from the group consisting of: an adhesive, hook and loop fasteners, screws, bolts and rivets.

18. The mold as claimed in claim 1, wherein the securing component comprises a faceplate having an inner surface for releasably securing to an outer surface of the mold body and a plurality of spaced apart magnets received in the faceplate and located opposite the inner surface, and a handle extending rearwardly of the faceplate.

19. The mold as claimed in claim 18, wherein the inner surface of the faceplate corresponds in shape to the outer surface of the mold body.

20. The mold as claimed in claim 1, further comprising a magnetic tool for releasably securing to a rearward surface of the embossing mold, the tool including a faceplate having an inner surface for releasably securing to an outer surface of the mold body and a plurality of spaced apart magnets received in the faceplate and located opposite the inner surface, and a handle extending rearwardly of the faceplate.

21. The mold as claimed in claim 20, wherein the inner surface of the faceplate corresponds in shape to the rearward surface of the embossing mold.

22. An apparatus for forming a candle body having a design embossed on at least one surface thereof, comprising:
a mold body having at least one side wall defining a mold cavity open at opposite ends thereof for receiving candle wax, the mold body defining an opening in the side wall;
an embossing mold having an embossing surface for forming the embossed design on the surface of the candle body; and
a plunger for moving the embossing mold between a retracted position in which the embossing mold is withdrawn from the opening in the side wall and an extended position in which the embossing mold is introduced into the opening.

23. The apparatus as claimed in claim 22, wherein the embossing surface corresponds in shape to the inner side surface of the mold body.

24. The apparatus as claimed in claim 22 or 23, further comprising a platen for securing the embossing mold, the embossing mold releasably securable to the platen, the plunger cooperating with the platen to move the embossing mold between the retracted position and the extended position.

25. The apparatus as claimed in claim 24, further comprising one or more magnets disposed against a surface of the platen for securing the embossing mold to the platen.

26. The apparatus as claimed in claim 24, further comprising one or more magnets integrally formed in the platen for securing the embossing mold to the platen.

27. The apparatus as claimed in any one of claims 22 to 26, further comprising a support member cooperating with the mold body to form a closed bottom for temporarily retaining the candle wax received therein.

28. A method for forming a candle body having a design embossed on at least one surface thereof, comprising the steps of:
selectively positioning an embossing mold within a mold cavity defined by a mold body;
securing the embossing mold to the mold body using magnets;
pouring liquefied candle wax into the mold cavity;
retaining the liquefied candle wax within the mold cavity for a period of time sufficient for the liquefied candle wax to solidify into a candle body; and
removing the candle body from the mold cavity.

29. The method as claimed in claim 28, wherein in the embossing mold comprises a flexographic printing plate having a metal backing plate formed of a magnetically responsive metal.

30. The method as claimed in claim 29, wherein in the step of securing the embossing mold to the mold body using magnets, the magnets are disposed against an outer surface of the mold body.

31. The method as claimed in claim 28, wherein the step of removing the candle body includes the step of separating the mold body into respective mold parts.

32. The method as claimed in claim 28, further comprising, before allowing the liquefied candle wax to solidify, the step of inserting a wick into the liquefied candle wax.

33. A method for embossing a design on a candle body, comprising the steps of:
retaining a candle body within a mold cavity defined by a mold body;
aligning an embossing mold with a surface of the candle body on which the design is to be embossed; and
compressing the candle body into the embossing mold with sufficient pressure to impart the embossed design.

34. The method as claimed in claim 33, wherein the step of aligning the embossing mold with the surface of the candle body on which the design is to be embossed comprises the steps of:
securing the embossing mold to a platen; and
introducing the platen with the embossing mold secured thereto into the mold cavity through an opening in a sidewall of the mold body.

35. The method as claimed in claim 34, wherein the embossing mold is secured to the platen using magnets.

36. In combination, a mold for forming a candle body having a design embossed on at least one surface thereof, the mold including a mold body having at least one inner side surface defining a mold cavity open at its top for receiving liquefied candle wax, comprising:
an embossing mold having an embossing surface for forming the embossed design on the surface of the candle body; and
a securing component for selectively securing the embossing mold to the inner side surface of the mold body such that the embossing mold may be secured to the mold body at any location on the inner side surface.

37. The combination as claimed in claim 36, wherein the embossing mold comprises a flexographic printing plate having a metal backing plate formed of a magnetically responsive metal, and the securing component comprises one or more magnets disposed against a surface of the mold body for securing the embossing mold to the mold body.

38. The combination as claimed in claim 36, wherein the securing component comprises a faceplate having an inner surface for releasably securing to an outer surface of the mold body and a plurality of spaced apart magnets received in the faceplate and located opposite the inner surface, and a handle extending rearwardly of the faceplate.

39. The mold as claimed in claim 36, further comprising a magnetic tool for releasably securing to a rearward surface of the embossing mold, the tool including a faceplate having an inner surface for releasably securing to an outer surface of the mold body and a plurality of spaced apart magnets received in the faceplate and located opposite the inner surface, and a handle extending rearwardly of the faceplate.

40. Use of a flexographic printing plate within a mold for forming a candle body having a design embossed on at least one surface thereof.

41. The use as claimed in claim 42, wherein the flexographic printing plate comprises a metal backing plate formed of a magnetically responsive metal, the flexographic printing plate secured to an inner side surface of the mold using one or more magnets disposed against an outer side surface of the mold.
